(19) United States
(12) Patent Application Publication
(10) Pub. No.: US 2007/0204162 A1
(43) Pub. Date: Aug. 30, 2007

(54) Safeguarding private information through digital watermarking

(76) Inventor: Tony F. Rodriguez, Portland, OR (US)

Correspondence Address: DIGIMARC CORPORATION, 9405 SW GEMINI DRIVE, BEAVERTON, OR, 97008, US

(21) Appl. No.: 11/361,672

(22) Filed: Feb. 24, 2006

(51) Int. Cl. H04L 9/00

(52) U.S. Cl. 713/176

(57) ABSTRACT

The present invention relates generally to digital watermarking and steganography. In one implementation, a method includes receiving permuted or encrypted data generated at a remote computing device, wherein the received data is encrypted or permuted according to a key carried by a digital watermark embedded in a security document; determining whether the received data matches or corresponds to data stored in a data repository, where the data repository indexes data stored therein without associating indexed data to a particular person or to an issued security document; and communicating an authentication indication to the remote computing device in accordance with a result of the act of determining.

### RELATED APPLICATION DATA

This application is generally related to the present assignee's following U.S. patent documents: U.S. Pat. Nos. 5,862,260; 6,442,285; 6,614,914; 6,804,378; 6,947,571; 6,970,573; Ser. No. 10/686,495 (published as US 2004-0181671 A1) and Ser. No. 10/370,421 (published as US 2004-0049401 A1). Each of the above U.S. patent documents is hereby incorporated by reference.

### TECHNICAL FIELD

The present invention relates generally to steganography and digital watermarking. In some implementations the present invention relates to authentication of physical and electronic objects.

### BACKGROUND AND SUMMARY

People are becoming ever more concerned about access to their private information. Identify theft is up. And today's online world presents countless opportunities for private information (e.g., social security numbers, driver's license numbers, birthdates, medical records, spending habits, family information, phone numbers, addresses, employment history, etc.) to become exposed for public consumption.

Competing with privacy is a need to authenticate and identify individuals and transactions. One is more willing to accept a check from a stranger if they see a driver's license. Even more comfort is found when the driver's license is proved to be authentic.

But there is an inherent conflict between privacy and authentication—a delicate balance between respecting private information while providing authentication and identity.

We provide solutions through digital watermarking and steganography.

Digital watermarking—a form of steganography—is a process for modifying media content to embed a machine-readable code into the content. The content may be modified such that the embedded code is imperceptible or nearly imperceptible to the user, yet may be detected through an automated detection process. Most commonly, digital watermarking is applied to media such as images, audio signals, and video signals. However, it may also be applied to other types of data, including text documents (e.g., through line, word or character shifting, background texturing, etc.), software, multi-dimensional graphics models, and surface textures of objects.

Digital watermarking systems have two primary components: an embedding component that embeds the watermark in the media content, and a reading component that detects and reads the embedded watermark. The embedding component embeds a watermark by altering data samples of the media content in the spatial, temporal or some other domain (e.g., Fourier, Discrete Cosine or Wavelet transform domains). The reading component analyzes target content to detect whether a watermark is present. In applications where the watermark encodes information (e.g., a plural-bit message), the reader extracts this information from the detected watermark.

The present assignee's work in steganography, data hiding and digital watermarking is reflected, e.g., in U.S. Pat. Nos. 5,862,260, 6,408,082, 6,614,914, 6,947,571; and in published specifications WO 9953428 and WO 0007356 (corresponding to U.S. Pat. Nos. 6,449,377 and 6,345,104). A great many other approaches are familiar to those skilled in the art. The artisan is presumed to be familiar with the full range of literature concerning steganography, data hiding and digital watermarking. Each of the above patent documents is hereby incorporated by reference.

According to one aspect of the present invention, a method is provided including: receiving permuted or encrypted data generated at a remote computing device, wherein the received data is encrypted or permuted according to a key carried by a digital watermark embedded in a security document; determining whether the received data matches or corresponds to data stored in a data repository, where the data repository indexes data stored therein without associating indexed data to a particular person or to an issued security document; and communicating an authentication indication to the remote computing device in accordance with a result of the determining.

In one implementation of the above aspect, data stored in the data repository is generated with a permuting or encryption process that corresponds to a process used to generate the received permuted or encrypted data.

According to another aspect, a method is provided including: receiving optical scan data representing at least a portion of a security document, wherein the security document comprises steganographic encoding including at least a key; decoding the steganographic encoding from the optical scan data to obtain the key; obtaining information carried by the security document; permuting or encrypting the information carried by the security document according to the key; communicating the encrypted or permuted information to a remote data repository, wherein the remote data repository indexes data stored therein without associating indexed data to a particular person or to an issued security document; receiving an authentication indication communicated from the remote data repository, the authentication indication providing an indication of whether the security document is valid or was validly issued.

In one implementation of the above aspect, the remote data repository determines whether the encrypted or permuted information matches or corresponds with data indexed therein.

In another implementation of the above aspect, data stored in the remote data repository is generated with a permuting or encryption act that corresponds to the act of permuting or encrypting, and wherein the stored data is indexed in the remote data repository according to at least one of issue date, issuing jurisdiction, issuing location, expiration date and document type.

Another aspect of the present invention is a watermark detector and embedder that are closely related to particular geographical areas.

For example, in one implementation, a method is provided including: determining a current geographic area; selecting a first digital watermark detection key that is associated with the current geographic area, a selected first digital watermark detection key being selected from a plurality of digital watermark detection keys; and controlling a digital watermark detector to employ the selected first digital watermark detection key to analyze a signal to obtain a digital watermark message there from, wherein the selected first digital watermark detection key corresponds to a particular digital watermark embedding key that is uniquely assigned to the geographic area.

In another implementation, a method is provided including, in a cell phone, determining a current geographic area of the cell phone; selecting a first digital watermark detector that is associated with the current geographic area, a selected first digital watermark detector being selected from a plurality of different digital watermark detectors; and controlling the cell phone to employ the selected first digital watermark detector to analyze a signal to obtain a digital watermark message there from, wherein the selected first digital watermark detector corresponds to a particular digital watermark embedder that is uniquely assigned to the geographic area.

In still another implementation, a cell phone is provided including: a radio-frequency transceiver; electronic processing circuitry; and memory. The memory includes executable instructions stored therein for processing by the electronic processing circuitry. The instructions include instructions to: determine a current geographic area of the cell phone; select a first digital watermark detector that is associated with the current geographic area, a selected first digital watermark detector being selected from a plurality of different digital watermark detectors; and control the cell phone to employ the selected first digital watermark detector to analyze a signal to obtain a digital watermark message there from. The selected first digital watermark detector corresponds to a particular digital watermark embedder that is uniquely assigned to the geographic area.

Further aspects, implementations, features and advantages will become even more apparent with reference to the following detailed description and accompanying drawings.

### BRIEF DESCRIPTION OF THE DRAWINGS

FIG. 1 illustrates a security document.

FIG. 2 illustrates database population.

FIG. 3 illustrates a system and method to validate the security document shown in FIG. 1 including communicating an authentication indicator.

FIG. 4 illustrates data stored in a database.

FIG. 5 illustrates a system and method to validate the security document shown in FIG. 1 including communicating an authentication indicator and age indicator.

FIG. 6 illustrates database searching over multiple databases.

FIG. 7 illustrates data indexed in a database according to security document issue date.

FIG. 8 illustrates embedding content with different keys according to geographic location.

FIG. 9 illustrates a cell phone including an optical sensor (e.g., a digital camera).

FIG. 10 is a block diagram illustrating a geography based, machine-readable detection.

### DETAILED DESCRIPTION

Safeguarding Private Information

Some of the following implementations under this section are provided in a driver's license context. It should be appreciated however that the teachings and systems described herein are applicable to many other types of security documents (e.g., passports, credit cards, checks, financial instruments, visas, identification documents, etc.) and authentication systems.

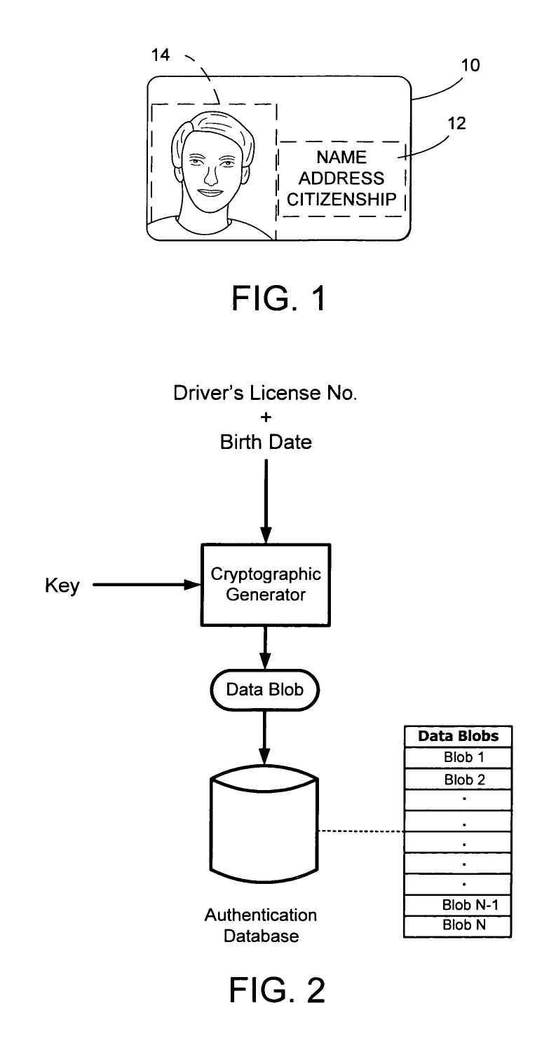

With reference to FIG. 1, a security document 10 is provided including printed (or engraved) information 12 and a photographic representation 14 (sometimes referred to as “photograph 14”) of an authorized bearer of document 10. Of course, document 10 as shown in FIG. 1 is an oversimplified example of a security document and most documents will include many additional features. These additional features, however, are not critical to this aspect of the invention.

Photograph 14 includes a digital watermark hidden therein (not illustrated in FIG. 1). The digital watermark is generally imperceptible to human observation, but is detectable through machine-analysis of optical scan data representing at least a portion of photograph 14. The digital watermark preferably includes a plural-bit payload. For example, the payload may include the following fields or information:

| | | |
|---|---|---|
| Driver's License No. | Bearer's Birth Date | Key |

The Driver's License Number and Birth Date are preferably identical to a license number and birth date printed or otherwise contained on the security document 10. In some cases, however, the driver's license number is abbreviated (e.g., only the first or second halves of the number are contained in the watermark payload).

The Key is preferably a plural-bit number that is associated with the document 10 or the bearer of document 10. The Key can be randomly generated during document 10 issuance or can be bearer selected.

For example, a customer heads a DMV to obtain a driver's license. One step in a driver's license process prompts the customer to enter a Key (e.g., 4-24 digit number) via a key pad or touch screen. In alternative implementations the Key is generated by a random or pseudo-random generator, with or without customer intervention. In still another implementation, a user enters numbers that are used to seed a random number generator to create a Key (e.g., 32-256 bits).

With reference to FIG. 2, the Key is used to encrypt, permute, scramble or otherwise manipulate information related to an issued security document or to the bearer of the security document. For example, the driver's license number and the bearer's birth date are encrypted or cryptographically permuted by a cryptographic generator according to the Key. The resulting output or “data blob” (e.g., an encrypted or permuted string or number) is provided to an authentication database (FIG. 2).

(There are many, many suitable encryption and permutation processes that can be successfully employed here. For example, the process may involve RSA, Diffie-Hellman, DSS, Blowfish, DES, CSA, IDEA or other encryption or permutation process. Still further the Key can be XORed or multiplied with the driver's license and birth date, or used as a seed number for a pseudorandom sequence generator, an index to a look up table that produces a vector or matrix, or a vector/matrix, etc. These resulting values can be used to permute the driver's license and birth date.)

To respect the privacy of the document bearer the data blob is stored in the Authentication Database without reference to the bearer or to the document 10. The fact that the data blob is present in the database, however, indicates that the blob is authentic. The Authentication Database is populated with a plurality of data blobs corresponding to other documents, each stored without reference to the documents or document bearer. Indeed, we prefer an anonymous system, one in which the data blobs are not directly associated with documents or bearers, to further enhance privacy.

The Key is preferably stored only on document 10 and not retained by the driver's license issuing authority (e.g., a state Department of Motor Vehicles or DMV) or stored in the Authentication Database. In many cases we envision that that a DMV will not itself host the Authentication Database, but will securely communicate data blobs to an Authentication Database—hosted by a third party—as documents issue.

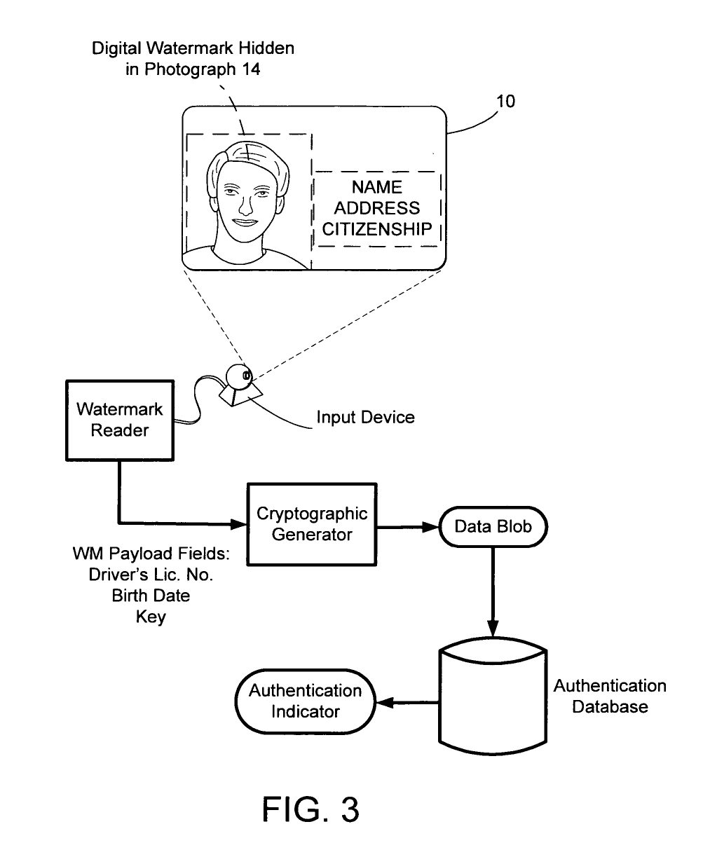

Document 10 is presented to an optical sensor or input device as shown in FIG. 3. For example, the input device may be part of a Document Authenticator System located in a liquor store, movie theater, a police officer's cell phone or PDA, or grocery store. The Document Authenticator System preferably includes or communicates with hardware (e.g., input device, electronic processing circuitry, memory, etc.) and software. The optical sensor captures optical scan data of the document 10 including at least a portion of photograph 14. (The digital watermark can be redundantly embedded in photograph 14 to enhance detection even in the presence of image cropping and partial image capture.). Watermark reader analyzes the optical scan data in search of the digital watermark. Once found, the digital watermark is decoded to obtain the watermark payload. In this example, the payload includes the driver's license number, the bearer's birth date and a bearer-selected Key.

The driver's license number, birth date and Key are provided to a cryptographic generator. The cryptographic generator contains the same or corresponding encryption or permutation algorithm as was used to generate a data blob corresponding to this security document 10, which is stored in an Authentication Database as discussed above with reference to FIG. 2. The cryptographic generator encrypts, permutes or manipulates the driver's license number and birth date according to the Key.

The data blob is communicated to the Authentication Database where it is compared against data blobs stored therein. One searching method is an exhaustive search. That is, the data blob securely communicated from a Document Authenticator System to the Authentication Database is compared against all other data blobs or until a matching or corresponding data blob is found. If a data blob is found a positive Authentication Indicator, e.g., Ok message, a yes bit, a green light bit, etc., is returned to the Document Authenticator. The positive Authentication Indicator is interpreted by the Document Authenticator System as an indication that document 10 is valid or was validly issued. (The Document Authenticator System may use the Authentication Indicator (e.g., a yes bit or a green light bit) to prompt a text message “YES” or “VALID” or to activate a light or LED (green for valid, etc.). If a matching or corresponding data blob is not found in the Authentication Database, a negative Authentication Indicator (e.g., a “Fail” message, a “no” bit, a red light bit, etc.) is returned to the Document Authenticator System.

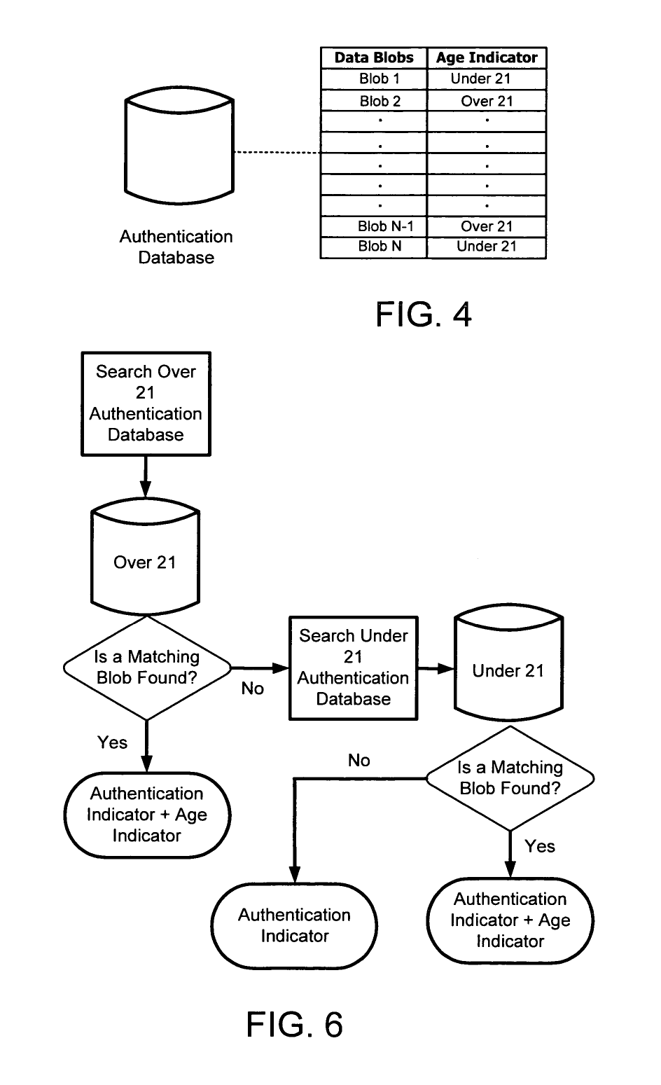

In some implementations the Authentication Database includes an age indicator. For example, and with reference to FIG. 4, an age indicator is associated with each data blob. The age indicator can be a simple “over 21” or “under 21” or include an actual age or birth date. (In these latter cases, the Authentication Database can store a birth date and update the age indicator as needed to reflect a current age of a bearer based, e.g., on the current date.)

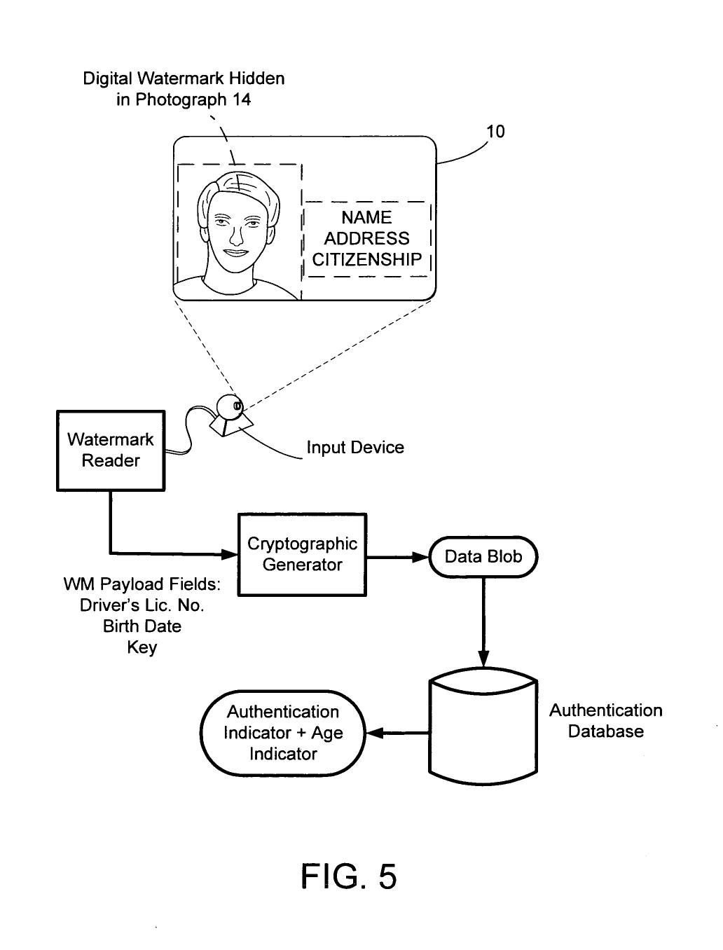

The age indicator is provided to a Document Authentication System along with an Authentication Indicator (see FIG. 5). The age indicator is useful in verifying a bearer's age for, e.g., alcohol, tobacco or firearm sales, participation in age restricted activities (e.g., entrance to movies, etc.).

Another implementation utilizes multiple databases, e.g., an over “21 database” and an “under 21” database. Data blobs are stored in a particular database according to an age of the corresponding bearer. Consider an example: Chuck is 19 years old. He heads to the DMV, fills out his forms, successfully passes the exam, enters a Key (which is used to create Chuck's data blob) and is issued a driver's license. Chuck's data blob is stored in the “under 21” database because is he is only 19. The data blob is preferably associated with a date (e.g., the date Chuck turns 21 or his birth date) that will clue the “under 21” database to move the data blob to the “over 21” database when Chuck turns 21.

(Even though we have referred to the data blob as “Chuck's data blob” it is useful to remember that the Authentication databases in this example do not have any record that the data blob is associated with Chuck.)

FIG. 6 illustrates an authentication process using a plurality of Authentication Databases based on age. A data blob is received from a Document Authenticator System. An “over 21” Authentication Database is searched to see if there is a corresponding data blob stored therein. If so, a positive Authentication Indicator and an age indictor are provided to the requesting Document Authenticator System. The age indictor can be generator from the mere presence of a matching data blob in the “over 21” database. The “under 21” Authentication Database is searched when a matching data blob is not found in the over 21 Authentication Database. A positive authentication indicator and an age indictor are sent to the requesting Document Authenticator System if a match is found. Otherwise, a negative Authentication Indicator is returned to the requesting Document Authenticator System.

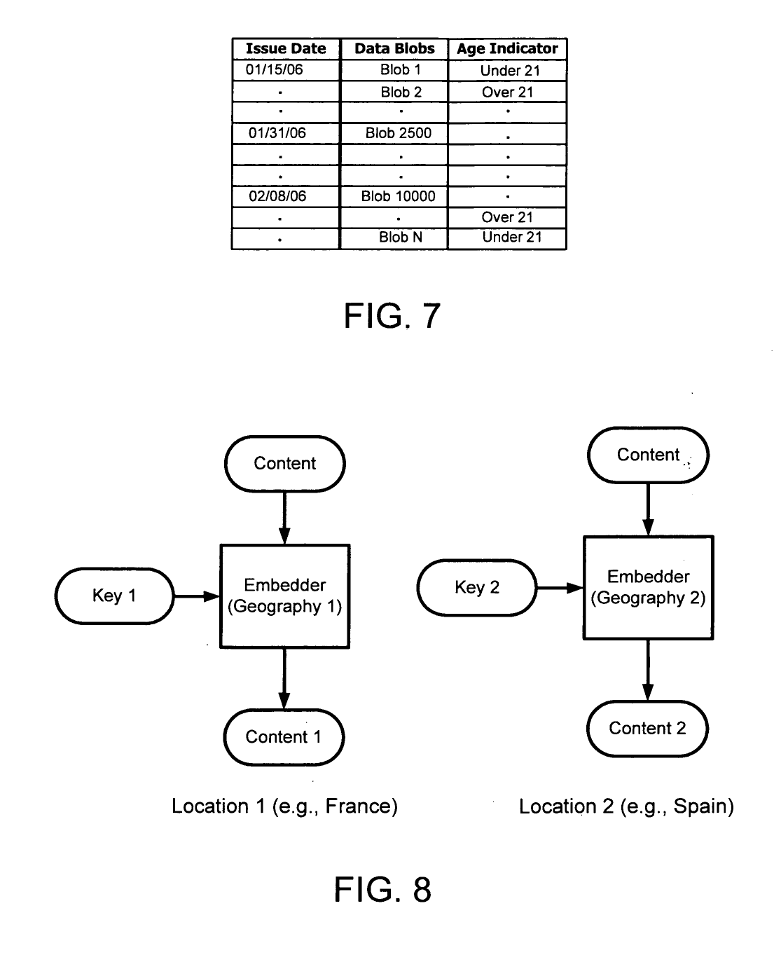

Having described the basic framework of our system, a few alternative implementations are noted below:
Information can be forwarded along with a data blob to an Authentication Database to help narrow database search parameters. This provides efficiencies over an exhaustive search as discussed above. For example, and with reference to FIG. 7, a document issue date (e.g., Jan. 31, 2006) is provided to the Authentication Database. The issue date can be, e.g., carried by a digital watermark, 2D barcode or manually entered after reading it from a security document. Only blobs stored under the corresponding issue date (Jan. 31, 2006) are searched for a match. Other search criteria can be used instead issue date. For example, data blobs can be organized in an authentication database according to issuing jurisdiction (e.g., Idaho or Oregon), issuing branch (e.g., branch 1 or branch 2), type of document (e.g., passport or driver's license), etc. This information is communicated to the authentication database, which uses this information to help narrow its search.
While we have used a Driver's License No. and birth date as examples of information that can be carried by a watermark and permuted by a Key, other combinations of information commonly carried by driver's licenses and passports can be used to create a data blob. For example, the data blob may include a permuted form of an address, city or state of residence, first, middle or last name, sex, driving restrictions, organ donor status, issue date, first licensed date, driver's license number, license expiration date, citizenship, birth place, hair color, weight, age, eye color, biometric template and/or any combination of the above.
In a related alternative, the information which is to be selected varies. For example, if the current day is Thursday, then a first set of data is selected for permuting, and if the current day is Friday, then a second, different set of data is selected. An Authentication Database can maintain multiple different data blobs which are organized according to at least days of the week. Other variations are of course expected, such as sets of data being selected based on time, location, use (grocery store vs. liquor store), etc. Related to this is that a security document may include two or more keys, which are selected for permuting data based on, e.g., date, time, location, use, etc. An Authentication Database will have a corresponding entry for each expected use, date, time, location, etc.
While we prefer that at least the Key is carried by a digital watermark embedded in the photograph of a document, other information—information permuted or encrypted to create a data blob—may be obtained from other document sources, e.g., a bar code or from data printed on the document (and OCRed). The digital watermark may even include an indication of which information (e.g., driver's license number and weight) should be used from the barcode when creating a data blob.
This alternative starts with the assumption that an individual needs to authenticate herself with a central registry, yet she has a reluctance to have the central registry retain any of her private information. She also has a reluctance to store encrypted information on her identification document because she wants to know what is put there by the government. (For example, if her document includes encrypted information there is little or no hope that she will be able to decipher the encryption.) For this reason she desires only plain text on her identification document. The solution is to hide steganographic indicia in a portrait carried by the identification document. The indicia carries a cryptographic key (e.g., either a symmetric or asymmetric key) and other personal information, e.g., date of birth or driver's license number. To authenticate, the identification document is optically scanned to obtain the indicia and recover the key and personal information. The key is used to encrypt personalized information carried by the document, e.g., via OCR, barcode or the information carried by the digital watermark, creating an encrypted string. The encrypted string is sent to the central registry, which has previously stored encrypted strings as part of document issuance. The encrypted string is compared to other encrypted strings for correspondence. If a match is found the identification document is authenticated. If no match is found, then the identification document is deemed suspect.
   Geographical Based Watermarking Keys

The present assignee has discussed key-based watermarking in a number of patent filings, e.g., in U.S. Pat. No. 6,614,914 and pending U.S. patent application Ser. No. 11/082,179, filed Mar. 15, 2004 (published as US 2005-0271246 A1), which are each hereby incorporated by reference. For example, one or more keys may be used to encrypt a message carried by a digital watermark. And another key or set of keys may be used to control generation of a watermark signal or mapping of information bits in a message to positions in a watermark information signal or carrier signal. A “key” in these contexts serve a function of making a digital watermark un-readable to anyone except those having the proper key.

Assignee's U.S. patent application Ser. No. 09/636,102, which claims the benefit of U.S. Provisional Application No. 60/191,778, discusses a detection system that accommodates different watermark types, perhaps each utilizing different protocols. The watermark protocols provide keys and other parameters specifying how to decode a watermark of a given type. The above patent documents are each hereby incorporated by reference.

In cases where a media object contains a watermark of an unknown type, a media file may specify the watermark type, e.g., through a parameter in a file header. The file browser, or other client of the core watermark module, may invoke the appropriate decoder by extracting the type parameter from the media object and passing it and a reference to the media file to the core module via an API (application program interface). The API routes the request to the appropriate core module, which in turn, extracts the watermark message, and returns it to the API. The API passes the message to the requesting application.

In the event that a type parameter is not available, the application or device processing the object may enumerate through all supported watermarking protocols to check if any protocol is present.

One improvement utilizes keys to designate or correspond to different geographical areas.

For example, a first (embedding) key is provided for use in a first geographical area or market (e.g., France). A corresponding first (detection) key is needed to decode a media signal embedded with the first (embedding) key.

A second, different (embedding) key is provided for use in a second, different geographical area or market (e.g., Spain). A corresponding second (detection) key is needed to decode a media signal embedded with the second, different (embedding) key.

The first and second keys are used to seed the same watermark embedder.

For example, with reference to FIG. 8, a first media provider located in France embeds first content (e.g., printed materials, audio, video and/or digital images) with a watermark embedder using the first (embedding) key. While a second media provider located in Spain embeds second content (e.g., printed materials, audio, video and/or digital images) with a watermark embedder using the second (embedding) key.

The first content and second content are distributed for public consumption.

In one implementation, watermark detectors are provided along geographical boundaries. That is, a first set of detectors are provided, e.g., in France, that include the first detection key. A second set of detectors are provided, e.g., in Spain, that include the second detection key. The first set of detectors are only able to detect watermarks embedded with the first embedding key while the second set of detectors are only able to detect watermarks embedded with the second embedding key.

But what if I take my cell phone from Spain, which includes a watermark detector including a second detection key, over to France? It seems unfortunate that my cell phone would not be able to detect watermarks in content in France.

Enter another improvement.

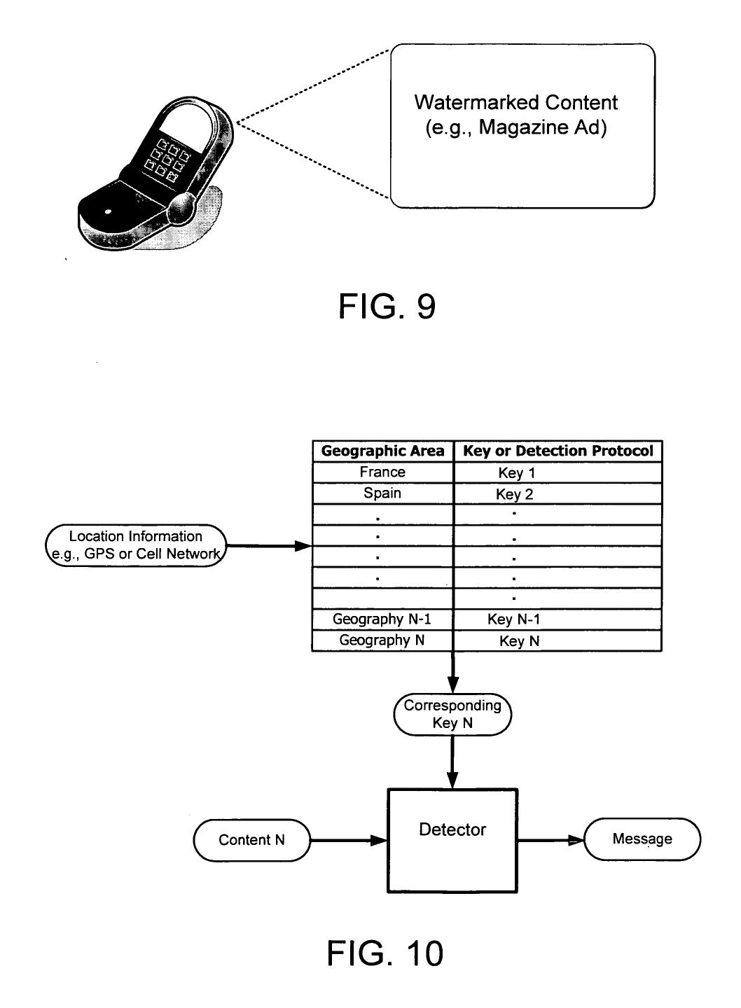

A cell phone in FIG. 9 includes a digital watermark detector (not shown in FIG. 9). In a first implementation, a watermark detector is configured to cycle through multiple different detection keys. That is, the watermark detector tries to detect a watermark hidden in content using a first detection key. If no watermark is recoverable, the watermark detector employs the second detection key to detect a watermark. If a watermark is still not recoverable, the watermark detector moves onto the third detection key, and so on, until a watermark is detected or until all detection keys are exhausted.

(The same watermark detection process is preferably used each time but detection is altered based on a particular detection key. As discussed above, the key may be a decryption key which is used to decipher a payload. Or, e.g., the key may provide locations within a carrier signal to look for message information, etc. Successful watermark detection is contingent upon using the right detection key.)

In a second implementation, efficiencies are provided through prioritizing detection keys based on geographic location.

For example, today's cell phones are sophisticated, some having Global Positioning System receivers that provide precise geo-coordinates. Such location information is used to determine which detection key should be tried first. (The watermark detector or cell phone can maintain a table or other association (e.g., FIG. 10). Location information is used to interrogate a registry or table to determine which key should be prioritized first. For example, geo-coordinates or other location information may indicate that the cell phone is located in Spain. The registry or table indicates that the corresponding detection key is the second detection key.) Instead of a GPS-equipped cell phone, the cell phone may receive location information from a cell tower or network, which is typically derived based on reception of cell phone signals at a plurality of cell towers. More generally, cell towers can provide general location information based on time zones, country or state of operation, etc.

Regardless of the source of the location information, the location information is used by the cell phone to determine a most likely detection key.

Once a detection key is decided upon, the watermark detector employs a selected key for watermark detection.

With reference to FIGS. 9 and 10, a cell phone preferably includes an optical sensor (e.g., a camera) to capture optical scan data. Captured optical scan data—corresponding to watermarked content (e.g., printed magazine advertisement, etc.)—is provided to the watermark detector (FIG. 10). Location information corresponding to a current location of the cell phone is used to select a detection key (Key N) from among a plurality of stored detection keys. The watermark detector employs the selected key during an attempt to detect and read a watermark from the captured optical scan data. If successful, the watermark is decoded to obtain a watermark message. If not successful, other keys can be tried for detection.

The watermark message can be used in a number of applications. For example, the watermark message provides a link to related content as discussed, e.g., in assignee's U.S. Pat. No. 6,947,571, which is hereby incorporated by reference.

The watermark message can also be used to control use or transfer of content. For example, instead of optically sensing an object, an audio or video file is received by the cell phone. The watermark detector sifts through the audio or video looking for a digital watermark embedded therein, based on a key associated with a location of the phone. Once found, the digital watermark is decoded to obtain a message. The message may include or link to usage rights associated with the audio or video. The usage rights control the cell phone regarding, e.g., redistribution or copying of the audio or video.

Some digital watermarks include an orientation component. The orientation component is often helpful in resolving issues such as signal distortion, scaling, rotation, translation, time warping, etc. The curious reader is encouraged to consult assignee's U.S. Pat. Nos. 6,975,744; 6,704,869; 6,614,914; 6,408,082; and 5,636,292 for an even further discussion of steganographic orientation techniques and components. Each of these patent documents is hereby incorporated by reference.

One implementation of this aspect of the invention first looks for the presence of an orientation component before selecting a key or cycling through different watermarking keys. If an orientation component is detected, a full watermark decoding operation is carried out to detect a message carried by the watermark. (This implementation presupposes that each embedding technique—each utilizing a different embedding key—embeds an orientation component independent of a specific embedding key. This independence will allow detection of at least the orientation component regardless of whatever key is used. The message or message locations, etc. of course can be obfuscated through use of an embedding key.)

As an alternative embodiment, instead of using different keys to trigger detection of a particular watermark, different watermark detectors are stored in memory of the cell phone. Each watermark detector corresponds to a particular geographic location. A current location is determined and that location is used to select a particular watermark detector. The selected watermark detector is loaded for execution.

In still another embodiment, a cell phone detector receives information from a network as to which detector it should use. This type of detection is affectionately referred to as a “network aware presence,” meaning a wireless carrier (or network) “pushes” an appropriate detector for that region or geographical area to the cell phone for the purpose of content watermark detection. The terms “appropriate detector” in this context refer to a detection key (e.g., a key is downloaded to the phone), an actual detector (software file) is downloaded, or an index key (e.g., number or seed) is pushed to the phone which allows the cell phone to access a previously stored table to identify which detector or detector key should be employed. As another example, if a cell phone is normally located in Spain, it would have the Spanish content detector loaded or installed on the phone; however, when the phone travels to a different location, like the United Kingdom, the “network aware presence” capability of the wireless carrier detects that the phone has now traveled to the United Kingdom and the content detector for the United Kingdom will be “pushed” automatically (preferably without user intervention) to the phone as a temporary file. The temporary file now becomes the primary content watermark detector. Once the user leaves that region, in this case, the United Kingdom, the temporary file is automatically deleted or de-prioritized and the phone's default content detector is reloaded or activated as the primary content detector.

In another embodiment, multiple different keys are assigned to each geographic location. For example, Spain may have 10 or more keys assigned to it, while France may have a different set of 10 or more keys assigned to it. In this way, if a particular key is compromised, there are still other keys available for that geography. When prioritizing keys for detection, all keys for a particular geography can be cycled through first or subsets of keys can be identified for higher prioritization.

While the above embodiments have been described as operating in a cell phone environment, the present invention is not so limited. Indeed, many other computing environments will benefit from these techniques. For example, PDAs, laptops, desktops, etc. that are able to determine a location of the device will similarly benefit.

Also our techniques of assigning a key or detector based on geographic location can apply to other machine-readable symbologies as well. For example, consider 2D barcodes. A barcode can be encrypted based on geographic area. For example, a first encrypting key is assigned to a first area and a second encrypting key is assigned to a second, different area, and so on. A detection process determines a current geographical area and finds a detector or decryption key that is associated with the area. A determined detector or decryption key is used to decode or decrypt the 2D symbology. (All told, however, we prefer steganography and digital watermarking, e.g., for their imperceptibility in many applications.)

Concluding Remarks

Having described and illustrated the principles of the technology with reference to specific implementations, it will be recognized that the technology can be implemented in many other, different, forms. To provide a comprehensive disclosure without unduly lengthening the specification, applicants hereby incorporates by reference each of the U.S. patent documents referenced above.

The methods, processes, components, modules, generators and systems described above may be implemented in hardware, software or a combination of hardware and software. For example, the watermark data decoding or permutation processes may be implemented in a programmable computer or a special purpose digital circuit. Similarly, watermark data decoding or cryptographic permutation process may be implemented in software, firmware, hardware, or combinations of software, firmware and hardware.

The methods, components and processes described above may be implemented in software programs (e.g., C, C++, Visual Basic, Java, executable binary files, etc.) executed from a system's memory (e.g., a computer readable medium, such as an electronic, optical or magnetic storage device).

The section headings are provided for the reader's convenience. Features found under one heading can be combined with features found under another heading. Of course, many other combinations are possible given the above detailed and enabling disclosure.

The particular combinations of elements and features in the above-detailed embodiments are exemplary only; the interchanging and substitution of these teachings with other teachings in this and the incorporated-by-reference U.S. patent documents are also contemplated.

What is claimed is:

1. A method comprising:
receiving permuted or encrypted data generated at a remote computing device, wherein the received data is encrypted or permuted according to a key carried by a digital watermark embedded in a security document;
determining whether the received data matches or corresponds to data stored in a data repository, wherein the data repository indexes data stored therein without associating indexed data to a particular person or to an issued security document; and
communicating an authentication indication to the remote computing device in accordance with a result of said act of determining.

2. The method of claim 1 wherein the key is embedded in a photograph carried by the security document.

3. The method of claim 1 wherein the received data comprises data carried by the security document that has been permuted or encrypted according to the key.

4. The method of claim 1 wherein the data repository associates an age indicator with data indexed therein, and wherein said act of communicating further communicates an age indicator to the remote computing device.

5. The method of claim 1 wherein data stored in the data repository is generated with a permuting or encryption process that corresponds to a process used to generate the received permuted or encrypted data.

6. The method of claim 5 wherein said data repository comprises a plurality of databases.

7. The method of claim 6 wherein data is stored in a particular database according to a bearer's age.

8. The method of claim 1 wherein data stored in the data repository is generated with a permuting or encryption process that corresponds to a process used to generate the received permuted or encrypted data, and wherein the stored data is indexed in the data repository according to at least one of issue date, issuing jurisdiction, issuing location, expiration date and document type.

9. The method of claim 1 wherein the authentication indication provides an indication of whether the security document is valid.

10. The method of claim 1 wherein the digital watermark is redundantly embedded in the security document.

11. A method comprising:
receiving optical scan data representing at least a portion of a security document, wherein the security document comprises steganographic encoding including at least a key;
decoding the steganographic encoding from the optical scan data to obtain the key;
obtaining at least some information carried by the security document, wherein the at least some information is associated with at least one of a bearer of the security document and the security document itself;
permuting or encrypting the at least some information carried by the security document according to the key;
communicating the encrypted or permuted information to a remote data repository, wherein the remote data repository indexes data stored therein without associating indexed data to a particular person or to an issued security document;
receiving an authentication indication communicated from the remote data repository, the authentication indication providing an indication of whether the security document is valid or was validly issued.

12. The method of claim 11 wherein the remote data repository determines whether the encrypted or permuted information matches or corresponds with data indexed therein.

13. The method of claim 11 wherein data stored in the remote data repository is generated with a permuting or encryption act that corresponds to said act of permuting or encrypting, and wherein the stored data is indexed in the remote data repository according to at least one of issue date, issuing jurisdiction, issuing location, expiration date and document type.

14. The method of claim 11 wherein the key is hidden in a photograph carried by the security document via digital watermarking.

15. The method of claim 14 wherein the photograph is carried by the security document through at least one of printing or storage in electronic memory circuitry carried by the security document.

16. The method of claim 14 wherein said act of obtaining information carried by the security document comprises obtaining information carried in at least one of a digital watermark, a bar code, a magnetic stripe and through optical character recognition (OCR) of data printed or engraved on the document.

17. The method of claim 11 wherein the data repository associates an age indicator with data indexed therein, and wherein said act of communicating further communicates an age indicator to the remote data repository.

18. The method of claim 11 wherein data stored in the data repository is generated with a permuting or encryption act that corresponds to said act of permuting or encrypting the information carried by the security document according to the key.

19. The method of claim 18 wherein the remote data repository comprises a plurality of databases.

20. The method of claim 19 wherein data is stored in a particular database according to a bearer's age.
